(19) United States
(12) Patent Application Publication
(10) Pub. No.: US 2017/0331567 A1
(43) Pub. Date: Nov. 16, 2017

(54) INFORMATION PROCESSING DEVICE, TERMINAL DEVICE, ELECTRONIC DEVICE, AND COMPUTER-READABLE RECORDING MEDIUM HAVING CONTROL PROGRAM RECORDED THEREON

(71) Applicant: FUJITSU LIMITED, Kawasaki-shi (JP)

(72) Inventor: Shotaro Hamao, Kawasaki (JP)

(73) Assignee: FUJITSU LIMITED, Kawasaki-shi (JP)

(21) Appl. No.: 15/492,435

(22) Filed: Apr. 20, 2017

(30) Foreign Application Priority Data
May 16, 2016 (JP) 2016-098259

(51) Int. Cl. H04B 17/27; H04B 17/318; H04B 17/12; H04W 64/00; H04W 84/12

(52) U.S. Cl. CPC H04B 17/27; H04B 17/318; H04B 17/12; H04W 84/12; H04W 64/006

(57) ABSTRACT

In an information processing device, a first device includes a first wireless communicator, a determiner that determines a movement pattern of the first device, and a notifier that notifies movement pattern information which indicates the movement pattern determined by the determiner via the first wireless communicator, and a second device includes a second wireless communicator that performs wireless communication with the first wireless communicator a the directional antenna, a driver that rotates the directional antenna, and a controller that performs control to drive the driver to rotate the directional antenna according to the notified movement pattern information, so that it is possible to enhance a radio field intensity of wireless communication between the first device and the second device.

### CROSS-REFERENCE TO RELATED APPLICATION

This application is based upon and claims the benefit of priority of the prior Japanese Patent application No. 2016-098259, filed on May 16, 2016, the entire contents of which are incorporated herein by reference.

### FIELD

The embodiment discussed herein is directed to an information processing device, a terminal device, an electronic device and a computer-readable recording medium having a control program recorded thereon.

### BACKGROUND

A computer system which includes a slate-type terminal (slate terminal) which includes a display and which a user can carry, and a cradle which is connected with and can communicate with this slate terminal and on which the slate terminal is detachably mounted.

It is known that, in this computer system, the cradle includes an image processing function and a wireless output function, and a method for using this computer system includes causing the cradle to output video data by radio to be played back, causing the slate terminal to receive this video data, causing the display to display the video data and browsing the video data.

In a conventional computer system, it is not known where the slate terminal is used, and therefore an omnidirectional antenna (nondirectional antenna) is mounted on the cradle to scan the slate terminal.

Japanese Patent Application Laid-Open No. 2004-120533

Japanese Patent Application Laid-Open No. 2013-197721

However, the nondirectional antenna has a lower radio field intensity than that of a directional antenna in such a conventional computer system. Thus, there is a problem that the nondirectional antenna is susceptible to a noise influence, a screen is disturbed and video images break up. Further, there is also a problem that the slate terminal needs to be used at a position near the cradle, and therefore the conventional computer system provides poor convenience.

### SUMMARY

According to an aspect of the embodiments, this information processing device is an information processing device includes: a first device; and a second device, and in which the first device includes a first wireless communicator, a determiner that determines a movement pattern of the first device, and a notifier that notifies movement pattern information via the first wireless communicator, the movement pattern information indicating the movement pattern determined by the determiner, and the second device includes a directional antenna, a second wireless communicator that performs wireless communication with the first wireless communicator via the directional antenna, a driver that rotates the directional antenna, and a controller that performs control to drive the driver to rotate the directional antenna according to the movement pattern information notified from the notifier.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating an external appearance of a computer system which is an example of an embodiment;

FIG. 2 is a view illustrating part of a hardware configuration of the computer system which is the example of the embodiment;

FIG. 3 is a functional configuration diagram of the computer system which is the example of the embodiment;

FIG. 4 is a view illustrating a directional antenna and a servo motor in the computer system which is the example of the embodiment;

FIG. 5 is a perspective view illustrating an arrangement of the directional antenna and the servo motor in a cradle of the computer system which is the example of the embodiment;

FIG. 6 is a view for explaining a method for specifying a maximum radio field intensity angle of the computer system which is the example of the embodiment;

FIG. 7A is a flowchart for explaining a method for controlling rotation of the directional antenna of the cradle in the computer system which is the example of the embodiment;

FIG. 7B is a flowchart for explaining the method for controlling rotation of the directional antenna of the cradle in the computer system which is the example of the embodiment; and

FIG. 7C is a flowchart for explaining the method for controlling rotation of the directional antenna of the cradle in the computer system which is the example of the embodiment.

### DESCRIPTION OF EMBODIMENT(S)

An information processing device, a terminal device, an electronic device and a recording medium having a control program recorded thereon according to an embodiment will be described below with reference to the drawings. In this regard, the following embodiment is an exemplary embodiment, and does not intend to exclude application of various modified examples and a technique which are not described in the embodiment. That is, the present embodiment can be variously modified and carried out without departing from a scope of the spirit of the present embodiment. Alternatively, each drawing does not mean that only components illustrated in each drawing are provided, and can include other functions.

(A) Configuration

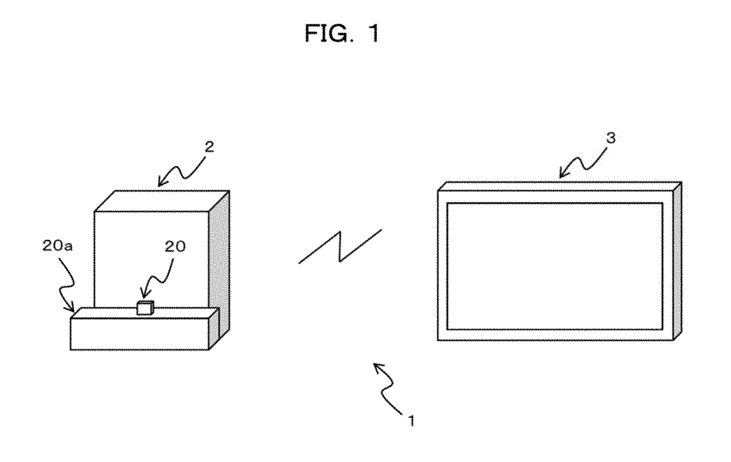

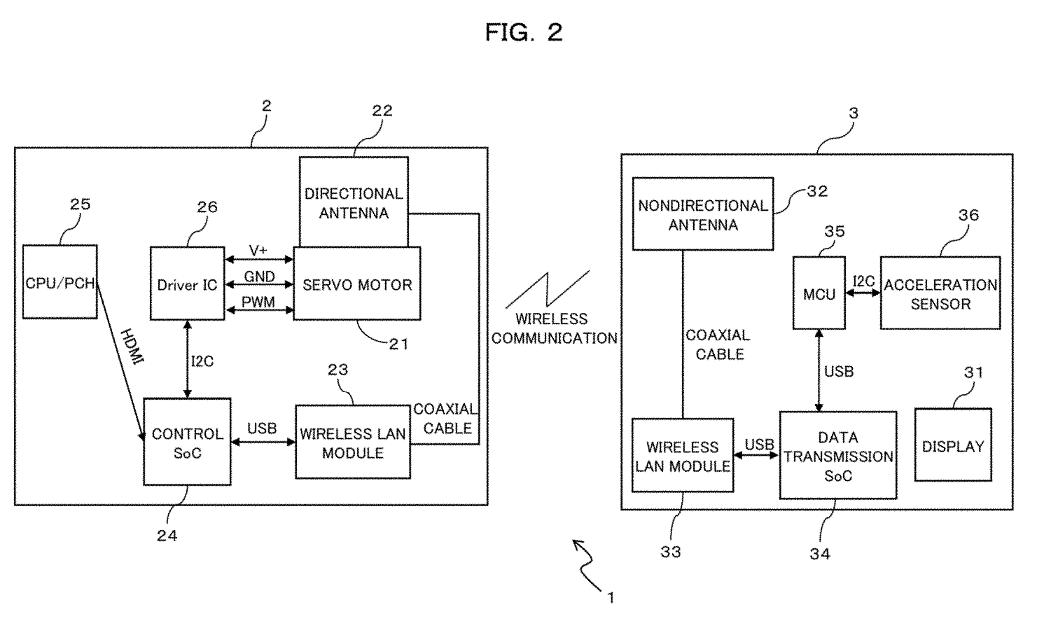

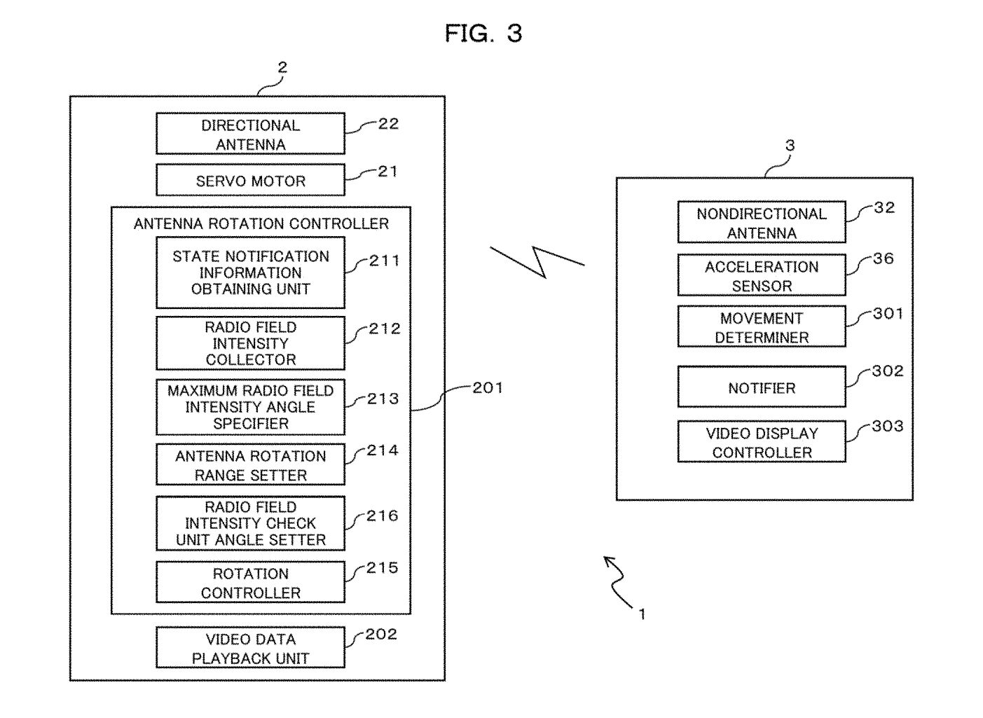

FIG. 1 is a view illustrating an external appearance of a computer system 1 which is an example of the embodiment, FIG. 2 is a view illustrating part of a hardware configuration of the computer system 1, and FIG. 3 is a functional configuration diagram.

The computer system 1 includes a cradle 2 and a slate terminal 3 as illustrated in FIG. 1.

[Slate Terminal]

The slate terminal (a first device and a terminal device) 3 is a slate-type terminal device which a user can carry, and includes a display 31, a nondirectional antenna 32, a wireless LAN (Local Area Network) module 33, a data transmission SoC (System on Chip) 34, a MCU (Micro Control Unit) 35 and an acceleration sensor 36 as illustrated in FIG. 2.

The display 31 is, for example, a liquid crystal display device, and displays various pieces of information. In the present embodiment, video data transmitted from the cradle 2 is displayed on this display 31.

In this regard, the display 31 may be, for example, a touch panel formed by combining a liquid crystal panel and a touch pad.

The nondirectional antenna 32 is an antenna which is also referred to as an omnidirectional antenna and does not have directivity, and transmits and receives radio waves. The nondirectional antenna 32 has an equal strength and sensitivity in all directions for transmission and reception of radio waves.

The wireless LAN module 33 is a communication device (first wireless communicator) which performs communication with the cradle 2 via a wireless LAN. The wireless LAN module 33 is connected with the nondirectional antenna 32 via a coaxial cable, and realizes wireless communication with the cradle 2 via this nondirectional antenna 32.

The data transmission SoC 34 is a circuit device which transmits data. The data transmission SoC 34 is connected with, for example, the wireless LAN module 33 and the MCU 35 via a USB bus.

For example, the data transmission SoC 34 relays video data received by the wireless LAN module 33 from the cradle 2 to the MCU 35.

Further, the data transmission SoC 34 transmits state notification information outputted from the MCU 35 (notifier 302) described below, to the cradle 2 via the wireless LAN module 33 and the nondirectional antenna 32.

The acceleration sensor 36 detects an acceleration of the slate terminal 3. The acceleration sensor 36 is, for example, a triaxial acceleration sensor which can measure accelerations in three axial directions of an X axis, Y axis and a Z axis. The acceleration sensor 36 can detect movement and a change in a posture such as an inclination of the slate terminal 3.

The acceleration sensor 36 is connected with the MCU 35 via, for example, an I2C (Inter-Integrated Circuit) bus.

The MCU 35 is an arithmetic processing device. The MCU 35 realizes various functions by executing programs stored in a memory which is not illustrated.

For example, as illustrated in FIG. 3, the MCU 35 realizes functions of a movement determiner 301, a notifier 302 and a video display controller 303.

The movement determiner (determiner) 301 determines (movement determination) whether or not the slate terminal 3 is moving. More specifically, the movement determiner 301 determines whether or not the slate terminal 3 is moving, based on measurement values of the respective X, Y and Z axis directions measured by the acceleration sensor 36.

For example, the movement determiner 301 can determine that, when a detection value (sensor value) of the acceleration sensor 36 does not change, there is not a posture change or a state change of the slate terminal 3 and the slate terminal 3 is not moving from the spot. A state where the slate terminal 3 is not moving, i.e., a state where the slate terminal 3 stops will be referred to as a pattern A hereafter.

Further, when the detection value of the acceleration sensor 36 changes, the movement determiner 301 then determines whether or not the user who holds the slate terminal 3 is walking. The movement determiner 301 determines (walking operation determination) whether or not the user who holds the slate terminal 3 is walking, based on the detection value of the acceleration sensor 36.

A state where the user who holds the slate terminal is walking will be also described as a state where the slate terminal 3 is in a state of walking movement. The movement determiner 301 determines whether or not the slate terminal 3 is in the state of walking movement.

In this regard, as disclosed in, for example, Japanese Laid-open Patent Publication No. 2005-114537, Japanese Laid-open Patent Publication No. 2009-212633 and Japanese Laid-open Patent Publication No. 10-113343, such walking operation movement can be realized by various known methods, and therefore will not be described.

Hereinafter, a state where the slate terminal 3 is moving (the detection value of the acceleration sensor 36 changes) yet the user who holds the slate terminal 3 is not walking as a result of the walking operation determination will be referred to as a pattern B. That is, the pattern B indicates that the slate terminal 3 is not in the state of walking movement.

A state where the slate terminal 3 is moving yet the user of the slate terminal 3 is not walking is considered as, for example, a case where the slate terminal 3 rotates on the spot or a case where the user of the slate terminal 3 is moving at such a slow speed level at which the user of the slate terminal is not technically walking (it is not determined that the user is walking).

Further, a state where the slate terminal 3 is moving (the detection value of the acceleration sensor 36 changes) and the user who holds the slate terminal 3 is walking as a result of the walking operation determination will be referred to as a pattern C. That is, the pattern C indicates that the slate terminal 3 is in the state of walking movement.

The notifier 302 notifies the cradle 2 of the result of movement determination and walking operation determination (state notification information) determined by the movement determiner 301.

That is, when the movement determiner 301 determines that the slate terminal 3 is in a stop state as a result of movement determination, the notifier 302 notifies the cradle 2 of the pattern A as the state notification information.

Further, when the movement determiner 301 determines that the slate terminal 3 is not in the state of the walking movement as the result of the walking operation determination, the notifier 302 notifies the cradle 2 of the pattern B as the state notification information. Furthermore, when the movement determiner 301 determines that the slate terminal 3 is in the state of the walking movement as the result of the walking operation determination, the notifier 302 notifies the cradle 2 of the pattern C as the state notification information.

The notifier 302 notifies the cradle 2 of one of the pattern A, B and C as the state notification information via the wireless LAN module 33 and the nondirectional antenna 32.

The video display controller 303 performs control to cause the display 31 to display video data. The video display controller 303 causes the display 31 to display the video data received by the data transmission SoC 34 from the cradle 2.

The data transmission SoC 34 of the slate terminal transmits the video data received by the wireless LAN module 33 to the MCU 35, and the video display controller 303 displays the video data on the display 31.

The video display controller 303 performs streaming playback for playing back this received video data in parallel to reception of the video data at the data transmission SoC 34 from the cradle 2.

Further, the slate terminal 3 includes a connector which is not illustrated and is connectable with a connector (see FIG. 1) of the cradle 2.

Furthermore, in the slate terminal 3, the MCU 35 executes control programs to function as the above movement determiner 301, the notifier 302 and the video display controller 303 described above.

In this regard, the programs (control programs) for realizing these functions of the movement determiner 301, the notifier 302 and the video display controller 303 are provided by being recorded in computer-readable recording media such as flexible disks, CDs (CD-ROMs, CD-Rs, and CD-RWs), DVDs (DVD-ROMs, DVD-RAMs, DVD-Rs, DVD+Rs, DVD-RWs, DVD+RWs, and HD DVDs), blu-ray disks, magnetic disks, optical disks and magnetooptical disks. Further, a computer (processor) reads a program from this recording medium, transfers the program to an internal storage device or an external storage device and stores the program in the internal storage device or the external storage device to use. Alternatively, this program may be recorded in a storage device (recording medium) such as a magnetic disk, an optical disk, and a magnetooptical disk, and may be provided in the computer from this storage device via a communication path.

The programs stored in the internal storage device (a memory of the slate terminal 3 in the present embodiment) are executed by a microprocessor (the MCU 35 of the slate terminal 3 in the present embodiment) of the computer to realize the functions of the movement determiner 301, the notifier 302 and the video display controller 303. In this case, the programs recorded in the recording medium may be read and executed by the computer.

[Cradle]

The cradle 2 is an installation-type expansion device (electronic device) on which the slate terminal 3 can be detachably mounted. By setting the slate terminal 3 on a setting base 20a (see FIG. 1) of the cradle 2, the connector of the cradle 2 joints to a connector of the slate terminal 3 which is not illustrated.

Thus, for example, power is supplied from the cradle 2 to the slate terminal 3 to charge a battery of the slate terminal 3 which is not illustrated.

A state where the slate terminal 3 is set on the setting base 20a of the cradle 2 and the connector of the cradle 2 is jointed to the slate terminal 3 will be also referred to as a DOCK state hereafter.

Further, the cradle 2 and the slate terminal 3 may be connected by a bus via the connector 20 in the DOCK state to transmit and receive various items of data. The cradle 2 may be connected with external devices (not illustrated) such as a keyboard, a mouse, a printer and an expanded I/O (Input/Output) port.

As illustrated in FIG. 2, the cradle 2 includes a servo motor 21, a directional antenna 22, a wireless LAN module 23, a control SoC 24, a CPU (Central Processing Unit) 25 and a driver IC (Integrated Circuit) 26.

The CPU 25 is a processing device which performs various types of control and various arithmetic operations, and realizes various functions by executing an OS or programs stored in a memory which is not illustrated.

Further, the CPU 25 is connected with a platform controller hub (PCH) which mutually connects a memory, a storage device, a USB (Universal Serial Bus) and a USB bus switch and enables communication therebetween.

The CPU 25 realizes a function of a video data playback unit 202 (see FIG. 3).

The video data playback unit 202 plays back, for example, video data stored in the storage device which is not illustrated. The function of the video data playback unit 202 is realized when, for example, the CPU 25 executes movie playback software. In this regard, the video data playback unit 202 can optionally change whether to play back video data stored in a recording medium such as a DVD or a Blu-ray disk or to play back video data obtained via the Internet.

The video data played back by the video data playback unit 202 is transmitted to the wireless LAN module 23 via the control SoC 24. Further, the video data is outputted by radio by the wireless LAN module 23 via the directional antenna 22. The video data outputted from the directional antenna 22 is received by wireless LAN module 33 via the nondirectional antenna 32 in the slate terminal 3, and is displayed on the display 31 of the slate terminal 3.

The wireless LAN module 23 is a communication device which communicates with the slate terminal 3 via a wireless LAN. The wireless LAN module 23 is connected with the directional antenna 22 via a coaxial cable, and realizes wireless communication with the slate terminal 3 via this directional antenna 23.

Further, the wireless LAN module 23 has a function of indicating an intensity of a radio wave (a radio field intensity and a reception intensity) received by the directional antenna 22 as a numerical value, and notifies the control SoC 24 of this radio field intensity.

The radio field intensity is obtained by measuring a radio field intensity of a response signal from the wireless LAN module 33 of the cradle 2 with respect to a signal (search signal) transmitted to the cradle 2 from the wireless LAN module 23 via the directional antenna 22. Measurement of a radio field intensity will be described as search for a radio field intensity. The radio field intensity is expressed in units of dBm, for example.

In this regard, the wireless LAN module 23 may notify the control SoC 24 of the radio field intensity on a regular basis, and may notify (respond to) the control SoC 24 of the radio field intensity in response to a request from the control SoC 24.

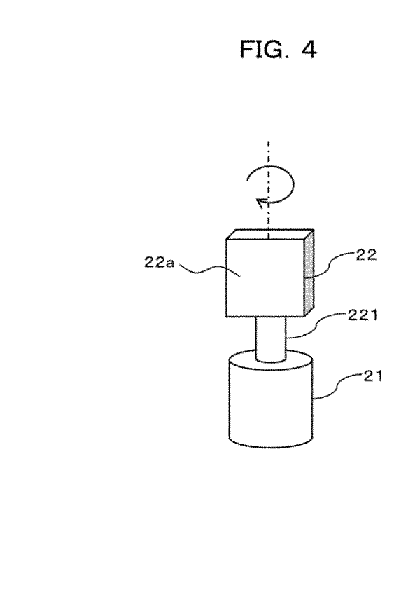

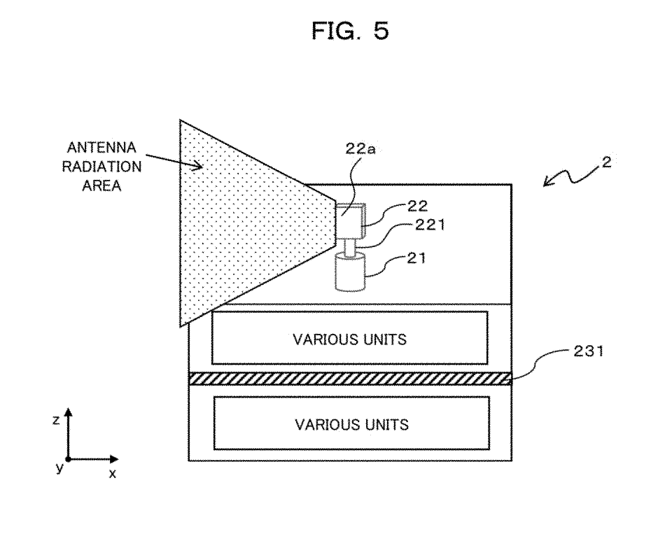

FIG. 4 is a view illustrating the directional antenna 22 and the servo motor 21 in the computer system 1 which is an example of the embodiment. FIG. 5 is a perspective view illustrating an arrangement of the directional antenna 22 and the servo motor 21 in the cradle 2.

The directional antenna 22 is an antenna which has directivity, and is an antenna which concentrates radiation of radio waves on a specific direction and an antenna which has a high reception sensitivity in the specific direction.

The directional antenna 22 has characteristics which enhance a radio field intensity of communication compared to nondirectional antennas, and can reduce interferences of other unnecessary radio waves and interferences with use of other radio waves.

The servo motor 21 is, for example, a stepping motor. As illustrated in FIG. 4, the directional antenna 22 is fixed to a rotary axis 221 of the servo motor 21, and the directional antenna 22 is rotated by rotating the rotary axis 221 according to a control signal (PWM (Pulse Width Modulation) control signal) inputted from the driver IC 26 described below.

Various units and a printed circuit board 231 are generally disposed at a position at a lower side in the cradle 2. The various units include the CPU 25, the control SoC 24, the driver IC 26, the wireless LAN module 23 and a storage device which is not illustrated.

Hence, as illustrated in FIG. 5, the directional antenna 22 and the servo motor 21 are desirably disposed, for example, above the positions at which the various units and the printed circuit board 231 are disposed in the cradle 2.

The directional antenna 22 is disposed at a position apart from the various units and the printed circuit board 231, and therefore does not receive noise caused by these units and the printed circuit board 231.

As illustrated in FIG. 5, the directional antenna 22 has a width in an upper and lower direction (vertical direction; see a Z axis direction in FIG. 5) from a radiation surface 22a which forms one surface of the directional antenna 22, and narrowly planarly emits radio waves in a horizontal direction (see an antenna radiation area in FIG. 5).

The slate terminal 3 can communicate with the cradle 2 well in a state where the nondirectional antenna 32 overlaps this planar antenna radiation area.

Further, the servo motor 21 is disposed such that the rotary axis 221 lies along the vertical direction. Further, the directional antenna 22 is fixed to the rotary axis 221 of this servo motor 21 such that the radiation surface 22a which emits radio waves is parallel to the rotary axis 221.

By rotating the rotary axis 221 of the servo motor 21, the antenna radiation area radially expanded with the width in the vertical direction from the radiation surface 22a of the directional antenna 22 rotates about the rotary axis 221. Rotation of the rotary axis 221 of the servo motor 21 will be described simply as rotation of the servo motor 21 hereafter.

Further, in the present embodiment, a rotation angle of the directional antenna 22 and a rotation angle of the rotary axis 221 of the servo motor 21 have the same meaning for ease of description.

Furthermore, the various units and the printed circuit board 231 in the cradle 2 are desirably disposed at positions which do not overlap the antenna radiation area of the directional antenna 22.

In the DOCK state where the slate terminal 3 is set on the setting base 20a of the cradle 2, an antenna rotation controller 201 described below positions the directional antenna 22 at a position at which the antenna radiation area is directed to the nondirectional antenna 32 of the slate terminal 3.

For ease of description, such a direction of the directional antenna 22 in the DOCK state will be referred to as a home position. At the home position, the rotation angle of the directional antenna 22 is set to an angle (rotation angle) at which the antenna radiation area is directed to the nondirectional antenna 32 of the slate terminal 3. Further, in the DOCK state where the slate terminal 3 is mounted on the cradle 2, the rotation angle of the directional antenna (servo motor 21) at this home position is set to 0° (reference angle).

The driver IC 26 is an integrated circuit which has a function of controlling rotation of the servo motor 21. The driver IC 26 receives an input of a PWM control signal for performing control to drive the servo motor 21 according to a motor control command inputted from the control SoC 24. Further, the driver IC 26 supplies power to the servo motor (see V+ and GND in FIG. 2).

Furthermore, the driver IC 26 notifies the control SoC 24 of the rotation angle of the servo motor 21, i.e., the rotation angle of the directional antenna 22.

The control SoC 24 is a circuit device which controls data transmission. The control SoC 24 is connected with the CPU 25 via, for example, a HDMI (High-Definition Multimedia Interface: registered trademark) bus. Further, the control SoC 24 is connected with the driver IC 26 via an I2C bus, and is further connected with the wireless LAN module 23 via a USB bus.

The control SoC 24 transmits video data to the wireless LAN module 23 according to, for example, an instruction from the CPU 25 described below, and causes the wireless LAN module 23 to transmit to video data to the slate terminal 3 by way of wireless communication.

Further, the control SoC 24 receives the state notification information notified from the slate terminal 3 via the directional antenna 22 and the wireless LAN module 23. Furthermore, the control SoC 24 inputs a motor control command to the driver IC 26.

Still further, the control SoC 24 realizes a function of the antenna rotation controller 201 which controls rotation of the directional antenna 22.

As illustrated in FIG. 3, the antenna rotation controller 201 includes a state notification information obtaining unit 211, a radio field intensity collector 212, a maximum radio field intensity angle specifier 213, an antenna rotation range setter 214, a radio field intensity check unit angle setter 216 and a rotation controller 215.

The state notification information obtaining unit 211 obtains state notification information (pattern A, B or C) notified from the slate terminal 3. The state notification information obtaining unit 211 sets, for example, a flag corresponding to the state notification information (pattern A, B or C) received from the slate terminal 3 to a register or the like which is not illustrated.

The radio field intensity collector 212 collects radio field intensities of the directional antenna 22. The radio field intensity collector 212 receives from the wireless LAN module 23, for example, radio field intensities of radio waves of data communication performed via the directional antenna 22. The radio field intensity collector 212 may collect the radio field intensity by inquiring the wireless LAN module 23 about the radio field intensity.

The radio field intensity collector 212 collects radio field intensities, for example, on a regular basis.

Further, the radio field intensity collector 212 associates a value of the collected radio field intensity with the rotation angle of the servo motor 21 (directional antenna 22) at a point of time at which this radio field intensity is measured to store in the memory or the like which is not illustrated. A measurement history of the radio field intensity associated with the rotation angle of the directional antenna 22 and stored will be also referred to as radio field intensity history information hereafter.

Further, the radio field intensity collector 212 compares a value of the obtained radio field intensity and a value of a previously obtained radio field intensity, and determines whether or not the radio field intensity has lowered.

The antenna rotation range setter (rotation range setter) 214 sets a ration range (antenna rotatable range) of the directional antenna 22, i.e., the rotation range of the servo motor 21 to scan the slate terminal 3.

The rotation angle of the directional antenna 22 for communicating with the slate terminal 3 will be also referred to as a search angle hereafter. The antenna rotation range setter 214 limits the search angle. By making the search angle small, it is possible to improve search efficiency of the slate terminal 3.

When the radio field intensity collector 212 determines that the radio field intensity has lowered, the antenna rotation range setter 214 limits the antenna rotatable range.

Further, the antenna rotation range setter 214 limits the antenna rotatable range according to the state notification information (pattern B or C) notified from the slate terminal 3.

When, for example, the state notification information notified from the slate terminal 3 is the pattern B, i.e., in a state where the slate terminal 3 is moving yet the user who holds the slate terminal 3 is not walking (the user not in the state of walking movement), the antenna rotation range setter 214 sets the antenna rotatable range to ±5° (first antenna rotatable range).

When the state notification information is the pattern B, it is highly probable that the slate terminal 3 is moving at such a slow speed level at which the user is not technically walking, so that it is possible to narrow the antenna rotatable range.

Further, when the state notification information notified from the slate terminal 3 is the pattern C, i.e., in a state where the slate terminal 3 is moving and the user who holds the slate terminal 3 is walking (the user is in the state of walking movement), the antenna rotation range setter 214 sets the antenna rotatable range to ±15° (second antenna rotatable range).

When the state notification information is the pattern C, it is highly probable that the user is walking and the slate terminal 3 is moving, so that it is possible to make the directional antenna 22 follow the movement of the slate terminal 3 and reliably capture the slate terminal 3 by widening the antenna rotatable range compared to that of the pattern B.

In addition, the value of the antenna rotatable range (such as ±5° or ±15°) corresponding to the state notification information is not limited to the above example and can be optionally modified and carried out.

The radio field intensity check unit angle setter 216 sets a rotation angle interval (radio field intensity check unit angle) at which the radio field intensity collector 212 collects the radio field intensities. The radio field intensity collector 212 collects the radio field intensity every time the servo motor 21 (directional antenna 22) rotates at the radio field intensity check unit angle.

The radio field intensity check unit angle setter 216 sets the radio field intensity check unit angle when the radio field intensity collector 212 determines that the radio field intensity has lowered.

Further, the radio field intensity check unit angle setter 216 sets the radio field intensity check unit angle according to the state notification information (pattern B or C) notified from the slate terminal 3.

For example, when the state notification information notified from the slate terminal 3 is the pattern B, i.e., in a state where the slate terminal 3 is moving yet the user who holds the slate terminal 3 is not walking (the user is not in the state of walking movement), the radio field intensity check unit angle setter 216 sets the radio field intensity check unit angle to 1° (first radio field intensity check unit angle).

The radio field intensity collector 212 obtains the radio field intensity every time the directional antenna 22 rotates at the radio field intensity check angle based on 0°, and stores the radio field intensity as radio field intensity history information.

When, for example, the radio field intensity check unit is 1°, the radio field intensity collector 212 obtains the radio field intensity every time the directional antenna 22 rotates 1°, and stores the radio field intensity as radio field intensity history information.

In this regard, an angle at which the radio field intensity collector 212 obtains a radio field intensity will be also referred to as a radio field intensity check angle.

When the state notification information is the pattern B, it is highly probable that the slate terminal 3 is moving at such a slow speed level at which the user is not technically walking, so that the directional antenna 22 can reliably capture the slate terminal 3 by narrowing the radio field intensity check unit angle.

Further, when the state notification information notified from the slate terminal 3 is the pattern C, i.e., in a state where the slate terminal 3 is moving and the user who holds the slate terminal 3 is walking (the user is in the state of walking movement), the antenna rotation range setter 214 sets the radio field intensity check unit angle to 5° (second radio field intensity check unit angle).

When the state notification information is the pattern C, it is highly probable that the user is walking and the slate terminal 3 is moving, so that it is possible to make the directional antenna 22 follow the movement of the slate terminal 3 and reliably capture the slate terminal 3 by widening the radio field intensity check unit angle compared to the pattern B.

In this regard, the value (such as 1° or 5°) of the radio field intensity check unit angle corresponding to the state notification information is not limited to the above example, and can be optionally modified and carried out.

The maximum radio field intensity angle specifier 213 specifies a position (rotation angle) of the directional antenna 22 at which the radio field intensity maximizes, based on the radio field intensity history information. The rotation angle of the directional antenna 22 at which the radio field intensity maximizes will be referred to as a maximum radio field intensity angle hereafter.

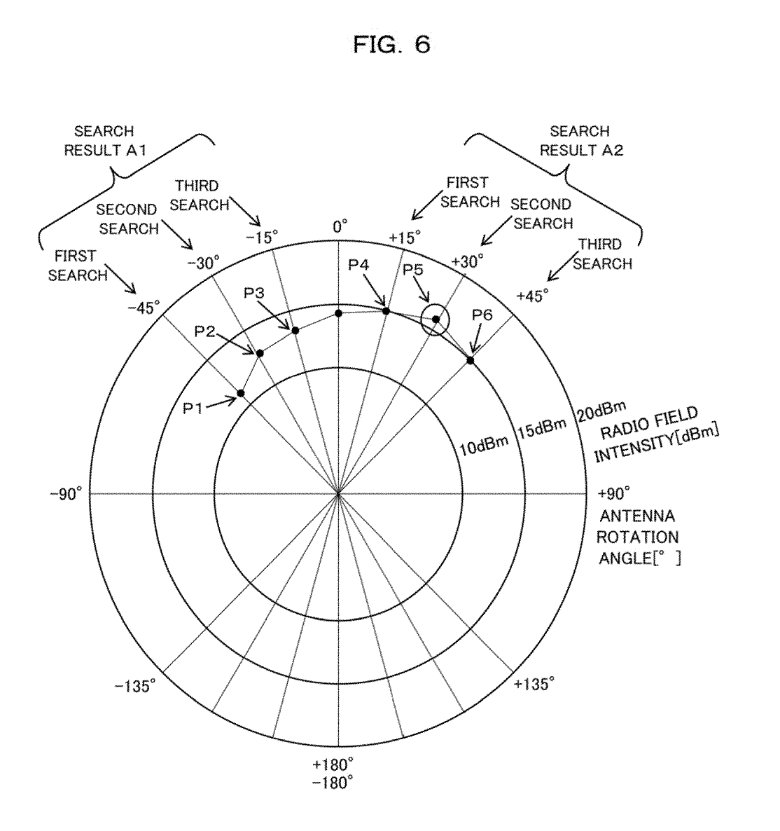

FIG. 6 is a view for explaining a method for specifying a maximum radio field intensity in the computer system 1 which is the example of the embodiment.

In the example illustrated in FIG. 6, the radio field intensity check unit angle is 15°, and radio field intensities are checked at 15° intervals in an angle range of −45° to +45° (radio field intensity confirmation unit angle=15°). That is, seven rotation angles of −45°, −30°, −15°, 0°, +15°, +30° and +45° correspond to the radio field intensity check angle, and the radio field intensity is collected per rotation angle.

For example, the maximum radio field intensity angle specifier 213 extracts (searches for) three continuous adjacent radio field intensity check angles from an end in order, and compares the respective radio field intensities. Further, in a combination in which the second searched radio field intensity check angle maximizes among the three continuous radio field intensity check angles in a search result, the radio field intensity check angle whose radio field intensity comes to a peak is determined as a maximum radio field intensity angle.

In the example illustrated in FIG. 6, radio field intensities at radio field intensities are confirmed in order from a smaller rotation angle.

In the example illustrated in FIG. 6, a search result A1 shows that the radio field intensity (see reference numeral P2) at the second searched radio field intensity check angle=−30° is higher than the first searched radio field intensity (see reference numeral P1) at the radio field intensity check angle=−45°. Further, the radio field intensity (see reference numeral P3) at the third searched radio field intensity check angle=−15° is higher than the radio field intensity (see reference numeral P2) at the second searched radio field intensity check angle=−30°.

Hence, the search result A1 shows that the third searched radio field intensity check angle is maximum, and therefore does not correspond to the combination in which the second searched radio field intensity check angle maximizes.

A search result A2 shows that the radio field intensity at the first searched radio field intensity check angle=+15° is 15 dBm (see reference numeral P4), the second searched radio field intensity check angle=+30° is 17 dBm (see reference numeral P5), and the third searched radio field intensity check angle=+45° is 15 dBm (see reference numeral P6).

17 dBm which is the radio field intensity at the second searched time radio field intensity check angle=+30° in this search result A2 is maximum among the seven radio field intensity check angles included in the angle range from −45° to +45°. Further, the second searched radio field intensity check angle is maximum in the search result A2.

Hence, the maximum radio field intensity angle specifier 213 specifies the second searched radio field intensity check angle=+30° in this search result A2 as the maximum radio field intensity angle.

Thus, the maximum radio field intensity angle specifier 213 compares the three continuous adjacent radio field intensity angles from the end in order, and determines a radio field intensity check angle whose radio field intensity comes to a peak as the maximum radio field intensity angle in the combination in which the second searched radio field intensity comes to a peak.

Further, the maximum radio field intensity angle specifier 213 sets the rotation angle determined as this maximum radio field intensity angle to 0° (reference angle). That is, a position of the reference angle (0°) of the rotation angle is updated by the maximum radio field intensity angle.

The rotation controller 215 controls rotation of the servo motor 21. The rotation controller 215 inputs a motor control command for instructing a rotation angle or a rotation speed of the servo motor 21, to the driver IC 26, thereby controls the rotation angle of the servo motor 21 and rotates the directional antenna 22.

The rotation controller 215 rotates the directional antenna 22 every predetermined rotation angle. In this regard, every rotation angle can be arbitrarily set. In this regard, every rotation angle is desirably the above radio field intensity check angle or less.

The rotation controller 215 rotates the directional antenna 22 in the antenna rotatable range set by the antenna rotation range setter 214.

Further, the rotation controller 215 rotates the directional antenna 22 at the rotation angle (maximum radio field intensity angle) of the directional antenna 22 which is specified by the maximum radio field intensity angle specifier 213 and at which the radio field intensity maximizes. Thus, the directional antenna 22 is set to the rotation angle at which the radio field intensity is maximum.

Further, in the cradle 2, a processor (a processing unit and a computer) such as a MPU (Micro-processor Unit) of the control SoC 24 which is not illustrated executes control programs (antenna control programs) to function as the state notification information obtaining unit 211, the radio field intensity collector 212, the maximum radio field intensity angle specifier 213, the antenna rotation range setter 214, the radio field intensity check unit angle setter 216 and the rotation controller 215.

In this regard, the programs (control programs and antenna control programs) for realizing the functions of the state notification information obtaining unit 211, the radio field intensity collector 212, the maximum radio field intensity angle specifier 213, the antenna rotation range setter 214, the radio field intensity check unit angle setter 216 and the rotation controller 215 are provided by being recorded in computer-readable recording media such as flexible disks, CDs (CD-ROMs, CD-Rs and CD-RWs), DVDs (DVD-ROMs, DVD-RAMs, DVD-Rs, DVD+Rs, DVD-RWs, DVD+RWs and HD DVDs), blu-ray disks, magnetic disks, optical disks and magnetooptical disks. Further, the computer (processor) reads a program from the recording medium, and transfers the program to and stores the program in the internal storage device or the external storage device to use. Alternatively, these programs may be recorded in storage devices (recording media) such as magnetic disks, optical disks and magnetooptical disks, and be provided from the storage device to the computer via a communication path.

The microprocessor (the CPU 25 of the cradle 2 in the present embodiment) of the computer executes the programs stored in the internal storage device (the memory of the control SoC 24 in the present embodiment) to realize the functions of the state notification information obtaining unit 211, the radio field intensity collector 212, the maximum radio field intensity angle specifier 213, the antenna rotation range setter 214, the radio field intensity check unit angle setter 216 and the rotation controller 215. In this case, the computer may read and execute the programs recorded in the recording medium.

(B) Operation

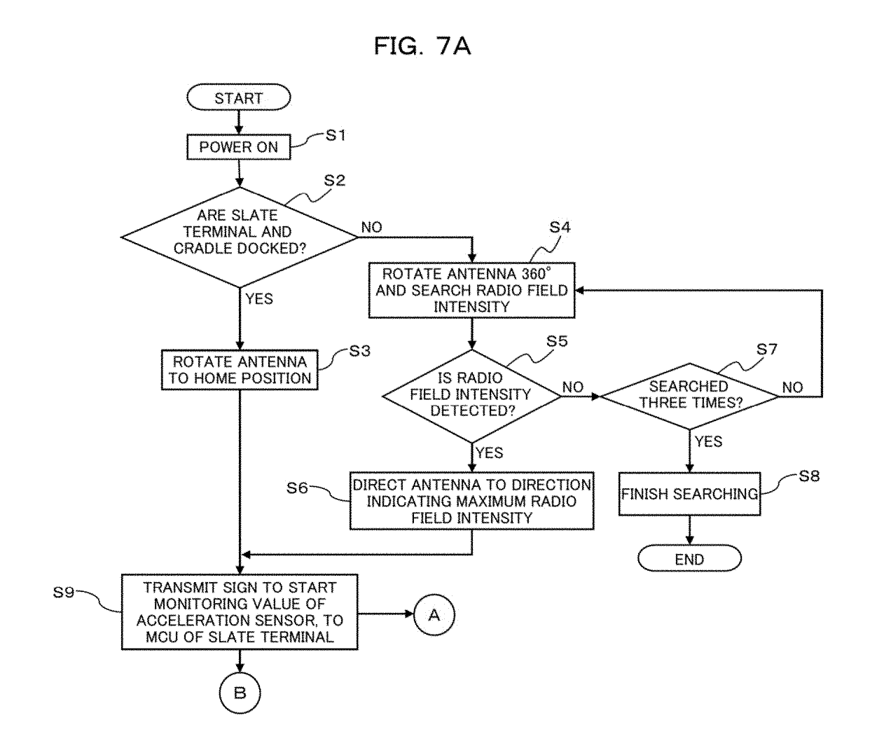

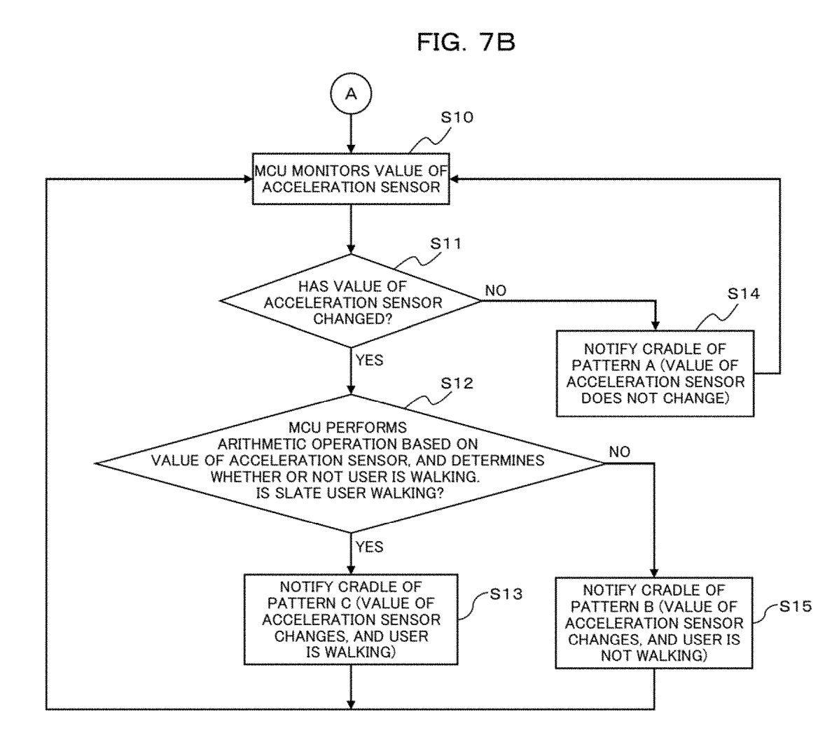

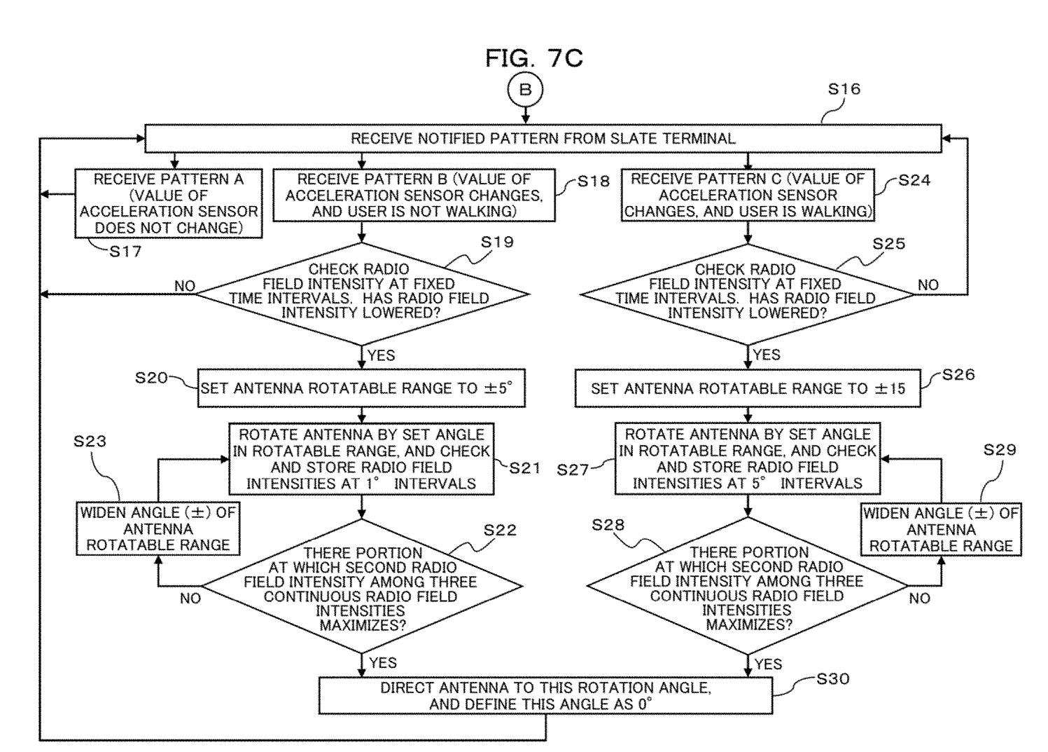

A method for controlling rotation of the directional antenna 22 of the cradle 2 in the computer system 1 which is the example of the embodiment employing the above configuration will be described according to flowcharts (steps S1 to S30) illustrated in FIGS. 7A to 7C.

In this regard, FIG. 7A illustrates the processes in steps S1 to S9, FIG. 7B illustrates the processes in steps S10 to S15, and FIG. 7C illustrates the processes in steps S16 to S30.

In following steps S1 to S9, the cradle 2 performs a default setting process to detect a position of the slate terminal 3.

In step S1 in FIG. 7A, the user powers on the computer system 1. In step S2, the antenna rotation controller 201 checks whether or not the slate terminal 3 and the cradle 2 are in the DOCK state.

When the slate terminal 3 is not attached to the cradle 2, (see a NO route in step S2), the process transitions to step S4 in FIG. 7A. In step S4, the rotation controller 215 rotates the directional antenna 22 360°, and the antenna rotation controller 201 outputs search signals to the cradle 2 at predetermined intervals and searches for the radio field intensity. In this regard, the detected radio field intensity is associated with the rotation angle of the directional antenna 22 at a point of time at which the radio field intensity is measured, and is stored in the memory or the like which is not illustrated.

In step S5 in FIG. 7A, the radio field intensity collector 212 checks whether or not a radio field intensity of a response signal from the slate terminal 3 has been detected. When the radio field intensity is detected as a result of the check (see a YES route in step S5), the process transitions to step S6 in FIG. 7A.

In step S6, a rotation angle of the directional antenna 22 from which a maximum radio field intensity has been detected as a result obtained by searching for a radio field intensity by rotating the directional antenna 22 360° in step S4 is determined as a default position, and the directional antenna 22 is directed to this rotation angle.

In a state where the slate terminal 3 is not mounted on the cradle 2, the rotation angle of the default position of this directional antenna 22 is determined as 0° (reference angle). Subsequently, the process transitions to step S9 in FIG. 7A.

Further, when the radio field intensity is not detected as the result of the check in step S5 (see a NO route in step S5), the process transitions to step S7 in FIG. 7A. In step S7, the antenna rotation controller 201 checks whether or not the radio field search performed in step S4 has been performed a predetermined number of times (e.g. three times in the present embodiment). When the number of times of searching for the radio field intensity is less than three (see a NO route in step S7), the process returns to step S4.

Further, when the number of times of searching for the radio field intensity is three (see a YES route in step S7), searching for the radio field intensity is finished in step S8 in FIG. 7A and the process is finished.

When the radio field intensity is not detected even if searching for the radio field intensity is repeated (retried) for a predetermined number of times (three times in the present embodiment), searching for the radio field intensity is finished to prevent a battery from running out. In this regard, when the cradle 2 is power on again, searching for the radio field intensity is resumed.

Meanwhile, when the slate terminal 3 is attached to the cradle 2 (see a YES route in step S2), the rotation controller 215 rotates the directional antenna 22 toward the home position in step S3.

In step S9, the antenna rotation controller 201 transmits to the slate terminal 3 a predetermined signal which is a monitoring start sign for starting monitoring a value of the acceleration sensor 36.

The slate terminal 3 which has received a notification signal for starting monitoring the value of the acceleration sensor 36 starts a determination process of the movement determiner 301.

That is, in step S10 in FIG. 7B, the MCU 35 (movement determiner 301) monitors the value of the acceleration sensor 36.

In step S11 in FIG. 7B, the movement determiner 301 checks whether or not a detected value of the acceleration sensor 36 has changed. When the detected value of the acceleration sensor 36 does not change as the result of check (see a NO route in step S11), the process transitions to step S14 in FIG. 7B.

In step S14, the value of the acceleration sensor 36 does not change, and therefore the slate terminal 3 is not moving from this spot. The notifier 302 notifies the cradle of the pattern A as the state notification information. Subsequently, the process returns to step S10.

Further, in case where the detected value of the acceleration sensor 36 has changed as the result of the check in step S11 (a YES route in step S11), the process transitions to step S12 in FIG. 7B.

In step S12, the MCU 35 (movement determiner 301) performs walking operation determination based on the detected value of the acceleration sensor 36. That is, whether or not the user who holds the slate terminal 3 is walking is determined.

When the user who holds the slate terminal 3 is not walking as the result of the check (see a NO route in step S12), the process transitions to step S15 in FIG. 7B.

In step S15, the notifier 302 notifies the cradle 2 of the pattern B as the state notification information indicating a state where the detected value of the acceleration sensor 36 changes yet the user who holds the slate terminal 3 is not walking. Subsequently, the process returns to step S10.

Further, when the user who holds the slate terminal is walking as the result of the check in step S12 (see a YES route in step S12), the process transitions to step S13 in FIG. 7B.

In step S13, the notifier 302 notifies the cradle 2 of the pattern C as the state notification information indicating a state where the detected value of the acceleration sensor 36 changes and the user who holds the slate terminal 3 is walking. Subsequently, the process returns to step S10.

Further, in step S9 in FIG. 7A, the antenna rotation controller 201 transmits to the slate terminal 3 a notification signal for starting monitoring the value of the acceleration sensor 36, and then the cradle 2 transitions to step S16 in FIG. 7C.

In step S16, the state notification information obtaining unit 211 obtains the state notification information (pattern A, B or C) notified from the slate terminal 3.

When the pattern A is received as the state notification information from the slate terminal 3 (step S17 in FIG. 7C), the process returns to step S16.

Meanwhile, when the slate terminal 3 receives the pattern B as the state notification information in step S16 (step S18 in FIG. 7C), the process transitions to step S19 in FIG. 7C.

In step S19, the radio field intensity collector 212 checks the radio field intensities at fixed time intervals. Further, the radio field intensity collector 212 compares the obtained radio field intensity and the previously obtained radio field intensity, and checks whether or not the radio field intensity has lowered.

When the radio field intensity does not lower as the result of the check (see a NO route in step S19), the process returns to step S16.

Further, in case where the radio field intensity has lowered as the result of the check (see a YES route in step S19), the process transitions to step S20 in FIG. 7C.

In step S20, the antenna rotation range setter 214 sets the antenna rotatable range to ±5°. It is highly probable that the slate terminal 3 is moving at such a slow speed that the user is not regarded to be walking, so that it is possible to improve communication quality of the slate terminal 3 by searching for a radio wave from a narrow rotation angle.

In step S21 in FIG. 7C, the rotation controller 215 rotates the directional antenna 22 every predetermined rotation angle in the antenna rotatable range set in step S20.

Further, the radio field intensity check unit angle setter 216 sets the radio field intensity angle to 1°, and the radio field intensity collector 212 collects and stores the radio field intensity every time the directional antenna 22 rotates 1° (at 1° intervals).

In step S22 in FIG. 7C, the maximum radio field intensity angle specifier 213 specifies a position (rotation angle) of the directional antenna 22 at which the radio field intensity maximizes. That is, the maximum radio field intensity angle specifier 213 checks whether or not there is a radio field intensity check angle at which the radio field intensity maximizes at the second (center) radio field intensity check angle among the three adjacent (continuous) radio field intensity check angles based on the radio field intensities obtained by the radio field intensity collector 212.

When there is no portion (maximum radio field intensity angle) at which the radio field intensity maximizes at the center radio field intensity check angle among the three adjacent radio field intensity check angles (see a NO route in step S22), the process transitions to step S23 in FIG. 7C.

In step S23, the angle of the antenna rotatable range is widened by a predetermined angle. Subsequently, the process returns to step S21.

Further, when there is the portion at which the radio field intensity maximizes at the center radio field intensity check angle among the three adjacent radio field intensity check angles as a result of the check in step S22 (see the YES route in step S22), the process transitions to step S30 in FIG. 7C.

In step S30, the directional antenna 22 is directed to a rotation angle indicated by the maximum radio field intensity angle. Further, the maximum radio field intensity angle specifier 213 sets the rotation angle determined as this maximum radio field intensity angle to 0° (reference angle). Subsequently, the process returns to step S16.

Further, in step S16, when the pattern C is received as the state notification information from the slate terminal 3 (step S24 in FIG. 7C), the process transitions to step S25 in FIG. 7C.

In step S25, the radio field intensity collector 212 checks the radio field intensities at fixed time intervals. Further, the radio field intensity collector 212 compares a value of the obtained radio field intensity and a value of the previously obtained radio field intensity, and checks whether or not the radio field intensity has lowered.

When the radio field intensity does not lower as a result of the check (see the NO route in step S25), the process returns to step S16.

Further, in case where the radio field intensity has lowered as the result of the check (see the YES route in step S25), the process transitions to step S26 in FIG. 7C.

In step S26, the antenna rotation range setter 214 sets the antenna rotatable range to ±15°.

It is highly probable that the user is walking and the slate terminal 3 is moving, so that it is possible to improve communication quality of the slate terminal 3 by searching for radio waves from a wide rotation angle.

In step S27 in FIG. 7C, the rotation controller 215 rotates the directional antenna 22 every predetermined rotation angle in the antenna rotatable range set in step S26.

Further, the radio field intensity check unit angle setter 216 sets the radio field intensity check angle to 5°, and the radio field intensity collector 212 collects and stores the radio field intensities every time the directional antenna 22 rotates 1° (at 5° intervals).

In step S28 in FIG. 7C, the maximum radio field intensity angle specifier 213 specifies a position (rotation angle) of the directional antenna 22 at which the radio field intensity maximizes. That is, the maximum radio field intensity angle specifier 213 checks whether or not there is a radio field intensity check angle at which the radio field intensity maximizes at the second (center) radio field intensity check angle among the three adjacent (continuous) radio field intensity check angles based on the radio field intensity obtained by the radio field intensity collector 212.

When there is not the portion (maximum radio field intensity angle) at which the radio field intensity maximizes at the center radio field intensity check angle among the three adjacent radio field intensity check angles as the result of the check (see the NO route in step S28), the process transitions to step S29 in FIG. 7C.

In step S29, the angle of the antenna rotatable range is widened by a predetermined angle. Subsequently, the process returns to step S27.

Further, when there is the portion at which the radio field intensity maximizes at the center radio field intensity check angle among the three adjacent radio field intensity check angles as the result of the check in step S28 (see a YES route in step S28), the process transitions to step S30 in FIG. 7C.

In step S30, the directional antenna 22 is directed to the rotation angle indicated by the maximum radio field intensity angle. Further, the maximum radio field intensity angle specifier 213 sets the rotation angle determined as this maximum radio field intensity angle to 0° (reference angle). Subsequently, the process returns to step S16.

(C) Effect

Thus, in the computer system 1 which is the example of the embodiment, the cradle 2 includes the directional antenna 22, so that it is possible to increase the radio field intensity of wireless communication between the cradle 2 and the slate terminal 3. Thus, it is possible to improve communication quality between the cradle 2 and the slate terminal 3.

When, for example, the cradle 2 transmits video data to the slate terminal 3, and the slate terminal 3 plays back the video data, the video is not disturbed.

Further, it is possible to make a distance from the cradle 2 at which the slate terminal 3 can be used long, and enhance convenience.

In the slate terminal 3, the movement determiner 301 performs walking operation determination based on a detected value of the acceleration sensor 36, and the notifier 302 notifies the cradle 2 of the state notification information which is a determination result.

The cradle 2 controls rotation of the directional antenna 22 according to the state notification information notified from the slate terminal 3, so that the cradle 2 can efficiently perform wireless communication with the slate terminal 3 by using the directional antenna 22.

When, for example, the slate terminal 3 is not in the state of the walking movement but is slowly moving, the antenna rotation range of the directional antenna 22 is set to a narrow range and, when the slate terminal 3 is in the state of the walking movement, the antenna rotation range of the directional antenna 22 is set to a wide range. Consequently, it is possible to rotate the directional antenna 22 in response to movement of the slate terminal 3, and the cradle 2 can efficiently perform wireless communication with the slate terminal 3 by using the directional antenna 22.

Further, in the cradle 2, the radio field intensity check unit angle setter 216 sets the radio field intensity check unit angle according to the state notification information (pattern B or C) notified from the slate terminal 3. Consequently, it is possible to efficiently collect the radio field intensity of communication with the slate terminal 3 according to movement of the slate terminal 3.

Further, the maximum radio field intensity angle specifier 213 specifies a rotation angle (maximum radio field intensity angle) of the directional antenna 22 at which the radio field intensity maximizes based on radio field intensity history information. Furthermore, the rotation controller 215 rotates the directional antenna 22 at the rotation angle (maximum radio field intensity angle) of the directional antenna 22 which is specified by the maximum radio field intensity angle specifier 213, and at which the radio field intensity maximizes. Thus, the directional antenna 22 is set to the rotation angle at which the radio field intensity is the highest. Consequently, the cradle 2 can perform wireless communication with the slate terminal 3 in a state of the highest radio field intensity.

(D) Other Points

Further, the disclosed technique is not limited to the above embodiment, and can be variously modified and carried out without departing from the spirit of the present embodiment. Each component and each process according to the present embodiment can be taken and left according to necessity or may be optionally combined.

For example, an example where the computer system 1 including the slate terminal 3 and the cradle 2 performs wireless communication between the slate terminal 3 and the cradle 2 has been described in the above embodiment. However, the present invention is not limited to this. For example, instead of the slate terminal 3, other peripheral devices and electronic devices may be applied. Further, instead of the cradle 2, the other electronic devices may include the directional antenna 22, the servo motor 21 and the antenna rotation controller 201.

Furthermore, in the above embodiment, the control SoC 24 of the cradle 2 has the function of the antenna rotation controller 201, yet is not limited to this. For example, the CPU 25 may execute the control program to realize the function of the control SoC 24, and this function can be variously modified and carried out.

In the above embodiment, the maximum radio field intensity angle specifier 213 extracts (searches for) three continuous adjacent radio field intensity check angles from an end in order, compares the respective radio field intensities, and determines a radio field intensity check angle whose radio field intensity comes to a peak as a maximum radio field intensity angle in a combination in which a second searched radio field intensity check angle maximizes, yet is not limited to this.

That is, the maximum radio field intensity angle specifier 213 may determine the radio field intensity check angle whose radio field intensity comes to a peak by using another method.

Further, one of ordinary skill in the art can carry out and manufacture the present embodiment based on the disclosure.

According to one embodiment, it is possible to increase a radio field intensity of wireless communication between a first device and a second device.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing device comprising:
a first device; and
a second device, wherein
the first device includes
a first wireless communicator,
a determiner that determines a movement pattern of the first device, and
a notifier that notifies movement pattern information via the first wireless communicator, the movement pattern information indicating the movement pattern determined by the determiner, and
the second device includes
a directional antenna,
a second wireless communicator that performs wireless communication with the first wireless communicator via the directional antenna,
a driver that rotates the directional antenna, and
a controller that performs control to drive the driver to rotate the directional antenna according to the movement pattern information notified from the notifier.

2. The information processing device according to claim 1, wherein
the first device includes an acceleration sensor, and
the determiner determines the movement pattern based on a detection signal of the acceleration sensor.

3. The information processing device according to claim 1, wherein the controller includes a rotation range setter that sets a rotation range of the directional antenna according to the movement pattern information notified from the first device.

4. The information processing device according to claim 1, wherein
the second device includes
a radio field intensity collector that collects a radio field intensity of the wireless communication performed between the information processing device and the first device, and
a maximum radio field intensity angle specifier that specifies a rotation angle of the directional antenna at which the radio field intensity maximizes, based on the radio field intensity collected by the radio field intensity collector, and
the controller rotates the directional antenna at the rotation angle of the directional antenna that is specified by the maximum radio field intensity angle specifier and at which the radio field intensity maximizes.

5. The information processing device according to claim 4, wherein the controller includes a radio field intensity check unit angle setter that sets a rotation angle interval of the radio field intensity collector to collect the radio field intensity according to the movement pattern information notified from the first device.

6. The information processing device according to claim 1, wherein
the controller
rotates the directional antenna in a first rotation range when the movement pattern information indicates that the first device is in a state of walking movement, and
rotates the directional antenna in a second rotation range narrower than the first rotation range when the movement pattern information indicates that the terminal device is not in the state of the walking movement.

7. A terminal device comprising:
a first wireless communicator that performs wireless communication with a fixed device;
a determiner that determines a movement pattern of the terminal device; and
a notifier that notifies the fixed device of movement pattern information via the first wireless communicator, the movement pattern information indicating the movement pattern determined by the determiner.

8. The terminal device according to claim 7, further comprising an acceleration sensor,
wherein the determiner determines the movement pattern based on a detection signal of the acceleration sensor.

9. An electronic device comprising:
a directional antenna that performs wireless communication with a terminal device;
a second wireless communicator that performs wireless communication with the terminal device via the directional antenna;
a driver that rotates the directional antenna; and
a controller that performs control to drive the driver to rotate the directional antenna according to the movement pattern information notified from the terminal device.

10. The electronic device according to claim 9, wherein the controller includes a rotation range setter that sets a rotation range of the directional antenna according to the movement pattern information notified from the terminal device.

11. The electronic device according to claim 9, further comprising:
a radio field intensity collector that collects a radio field intensity of the wireless communication performed between the electronic device and the terminal device; and
a maximum radio field intensity angle specifier that specifies a rotation angle of the directional antenna at which the radio field intensity maximizes, based on the radio field intensity collected by the radio field intensity collector,
wherein the controller rotates the directional antenna at the rotation angle of the directional antenna that is specified by the maximum radio field intensity angle specifier and at which the radio field intensity maximizes.

12. The electronic device according to claim 11, wherein the controller includes a radio field intensity check unit angle setter that sets a rotation angle interval of the radio field intensity collector to collect the radio field intensity according to the movement pattern information notified from the terminal device.

13. The electronic device according to claim 9, wherein
the controller
rotates the directional antenna in a first rotation range when the movement pattern information indicates that the terminal device is in a state of walking movement, and
rotates the directional antenna in a second rotation range narrower than the first rotation range when the movement pattern information indicates that the terminal device is not in the state of the walking movement.
